(19) United States
(12) Patent Application Publication
(10) Pub. No.: US 2021/0063789 A1
(43) Pub. Date: Mar. 4, 2021

(54) DISPLAY SCREEN, MANUFACTURING METHOD THEREOF, AND DISPLAY DEVICE

(71) Applicant: Wuhan China Star Optoelectronics Technology Co., Ltd., Wuhan, Hubei (CN)

(72) Inventor: Shaokun LI, Wuhan, Hubei (CN)

(21) Appl. No.: 16/623,708

(22) PCT Filed: Nov. 5, 2019
(86) PCT No.: PCT/CN2019/115638

§ 371 Date: Dec. 17, 2019

(30) Foreign Application Priority Data
Sep. 4, 2019 (CN) 201910833876.7

(51) Int. Cl. G02F 1/13357; C09J 7/35; C09J 7/10

(52) U.S. Cl. CPC G02F 1/1336; C09J 7/35; G02B 6/0055; G02F 2202/28; C09J 7/10

(57) ABSTRACT

The present disclosure provides a display screen, a manufacturing method thereof, and a display device. The display screen comprises a backlight module, a display panel, and an adhesive layer. The display panel is disposed on the backlight module. The adhesive layer is disposed between the backlight module and the display panel, and corresponds to the non-display area. Material of the adhesive layer is a hot melt adhesive.

### FIELD OF INVENTION

The present disclosure relates to the field of display technologies, and more particularly to a display screen, a manufacturing method thereof, and a display device.

### BACKGROUND OF INVENTION

Because intelligent terminals, such as mobile phones and tablet computers, are integrated with convenience characteristics, entertainment and functional diversity in one body, they have become indispensable parts in people's daily lives. With development of terminal technology, more advanced technologies are used in intelligent terminals and enrich people's lives greatly. However, people's requirements and expectations for intelligent terminals are also getting higher and higher. While enjoying the basic functions brought by intelligent terminals, such as mobile phones and tablet computers, people also put forward higher requirements for intelligent terminals, such as full screen designs of intelligent terminals.

The full screen is a broader definition of mobile phone designs with ultra-high screen ratios in mobile phone industry. Literally, that is, an entire front surface of a mobile phone is all screen, four edge sides of mobile phones are without frames, pursuing a 100% screen ratio. At first, full screen mobile phones improve their appearance, making it have more sense of technology. In addition, a same front surface area of full screen mobile phones can accommodate a greater screen, significantly improving visual experience.

However, due to attachment and fixing requirements among film layers in display devices, a design without frames cannot completely achieved. A conventional method to narrow borders of frames in display devices is to narrow a glue layer, which is for assembly bonding. It has a predetermined effect by narrowing the glue layer, but a frame glue is used to form the glue layer in conventional technology, if the frame glue is too narrow, it is more difficult to form and cut later, size tolerance is hard to handle, and uniformity of widths of the glue layer is difficult to ensure. Meanwhile, method of the frame glue is similar to double-sided tapes, it has no better rework technology for re-processing of display devices. Besides, when the frame glue is narrowed, there may be defects, such as water vapor intrusion and peeling off in environment test verification, thereby causing low reliability.

### SUMMARY OF INVENTION

An object of the present disclosure is to provide a display screen, a manufacturing method thereof, and a display device to solve the problems of broader frames of display devices, non-uniformity of widths, difficult to rework, and low reliability in current technology.

To achieve the above object, the present disclosure provides a display screen. The display screen has a display area and a non-display area surrounding the display area. The display screen comprises a backlight module, a display panel, and an adhesive layer. The display panel is disposed on the backlight module. The adhesive layer is disposed between the backlight module and the display panel, and corresponding to the non-display area. Wherein material of the adhesive layer is a hot melt adhesive.

Further, a curing temperature of the hot melt adhesive ranges from 40° C. to 60° C., and a melting temperature of the hot melt adhesive ranges from 80° C. to 100° C.

Further, a width of the adhesive layer is less than 0.5 mm.

Further, the width of the adhesive layer ranges from 0.2 mm to 0.3 mm.

Further, a color of the adhesive layer is black.

The present disclosure further provides a manufacturing method of a display screen. The manufacturing method comprises following steps:

providing a backlight module and a display panel;

forming an adhesive layer on the display panel;

attaching the backlight module to a surface of the adhesive layer away from the display panel, wherein material of the adhesive layer is a hot melt adhesive.

Further, in the step of forming the adhesive layer on the display panel comprises: forming the adhesive layer on edges of one surface of the display panel by time pressure dispensing method.

Further, in the step of attaching the backlight module to the adhesive layer further comprises: placing the adhesive layer in an environment at a temperature of 40° C. to 60° C. and heating to cure.

Further, a width of the prepared adhesive layer is less than 0.5 mm, and a color thereof is black.

The present disclosure further provides a display device. The display device comprises the above display screen.

The advantage of the present disclosure is: the display screen and the display device use a hot melt adhesive as the adhesive layer bonding the backlight module and the display screen, preventing water vapor intrusion, improving reliability, and meanwhile improving screen ratio, thereby achieving full screens. In addition, the manufacturing method of the display screen is simple, time for preparation is short, it also facilitates return to factories for reworking of the display screen, thereby reducing human and material resources, and reducing costs.

### DESCRIPTION OF DRAWINGS

FIG. 1 is a schematic layered diagram of a display screen according to an embodiment of the present disclosure.

FIG. 2 is a schematic planar diagram of a hot melt adhesive according to an embodiment of the present disclosure.

FIG. 3 is a schematic layered diagram of a backlight module according to an embodiment of the present disclosure.

FIG. 4 is a flowchart of a manufacturing method according to an embodiment of the present disclosure.

### DETAILED DESCRIPTION OF PREFERRED EMBODIMENTS

The preferred embodiments of the present disclosure are described in detail below with reference to the accompanying drawings. The specific embodiments described with reference to the attached drawings are all exemplary and are intended to illustrate and interpret the present disclosure to make the skilled in the art easier to understand how to implement the present disclosure. The disclosure herein provides many different embodiments or examples for realizing different structures of the present disclosure. They are only examples and are not intended to limit the present disclosure. In the accompanying drawings, wherein the identical or similar reference numerals constantly denote the identical or similar elements or elements having the identical or similar functions. In the drawings, structurally identical components are denoted by the same reference numerals, and structural or functionally similar components are denoted by like reference numerals.

Moreover, a size and a thickness of each component shown in the drawings are arbitrarily shown, and the present disclosure does not limit the size and thickness of each component. In order to make the drawings clearer, thicknesses of some components in the drawings are appropriately exaggerated.

Besides, the specific embodiments described with reference to the attached drawings are all exemplary and are intended to illustrate and interpret the present disclosure. In the description of the present disclosure, it should be understood that terms such as “upper”, “lower”, “front”, “rear”, “left”, “right”, “inside”, “outside”, “side”, as well as derivative thereof should be construed to refer to the orientation as described or as shown in the drawings under discussion. These relative terms are for convenience of description, do not require that the present disclosure be constructed or operated in a particular orientation, and shall not be construed as causing limitations to the present disclosure. In addition, terms such as “first” and “second” are used herein for purposes of description and are not intended to indicate or imply relative importance.

When a component is described as “on” another component, the component can be placed directly on the other component; an intermediate component can also exist, the component is placed on the intermediate component, and the intermediate component is placed on another component. When a component is described as “installed to” or “connected to” another component, it can be understood as directly “installed to” or “connected to”, or a component is “mounted to” or “connected to” another component through an intermediate component.

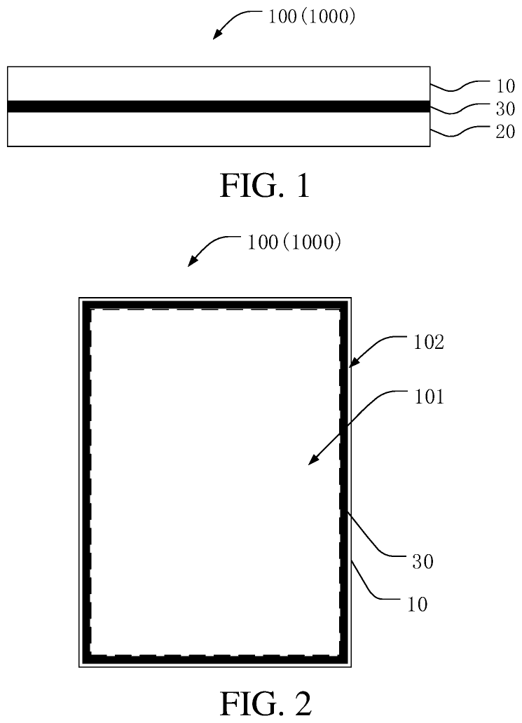

An embodiment of the present disclosure provides a display screen 100, as shown in FIG. 1. The display screen 100 comprises a backlight module 20, a display panel 10, and an adhesive layer 30. The display screen 100 further comprises a display area 101 and a non-display area 102 surrounding the display area 101.

The backlight module 20 has a light-emitting surface. The backlight module 20 is used to provide a light source for the display panel 10, and the light source is emitted from the light-emitting surface. The display panel 10 is disposed on one side of the light-emitting surface of the backlight module 20. The display panel 10 can be a liquid crystal display panel 10 (LCD) for providing a display picture.

The liquid crystal display panel 10 is a display panel 10 using liquid crystals as material. Liquid crystals are a special substance between a solid and a liquid. It is an organic compound which is in a liquid state under normal conditions, but its molecular arrangement is as regular as a solid crystal, so it is named liquid crystal. Another special property is that under effect of an electric field, liquid crystal molecules will have alignment changes, thereby affecting light passing through to change. The changes of light can be expressed as bright and dark changes through effect of polarizers. In this way, people can control bright and dark changes of light by controlling electric fields, thereby achieving the object of display. If used with color filters and changing voltages applied to liquid crystals, transmission of a certain color can be changed. That is, changing voltages of both ends of liquid crystals can change their transmittance.

The backlight module 20 is a backlight 25 disposed under the liquid crystal display panel 10. Its illuminating effect will directly affect visual effect of the liquid crystal display panel 10. The liquid crystal display panel 10 is a passive light-emitting element, which does not emit light by itself. Pictures or images it displays are results of adjustment of light provided by the underneath backlight module 20. The backlight module 20 and the liquid crystal display panel 10 are combined to form a liquid crystal display module.

The backlight module 20 includes optical film structure layers and a backlight 25. The optical film structure layers conventionally include a reflective film 21, a light guide plate 22, a prism sheet 24, a diffusion film 23, etc., and the films are stacked in the backlight module 20. The backlight 25 is disposed on one side or both sides of the backlight module 20.

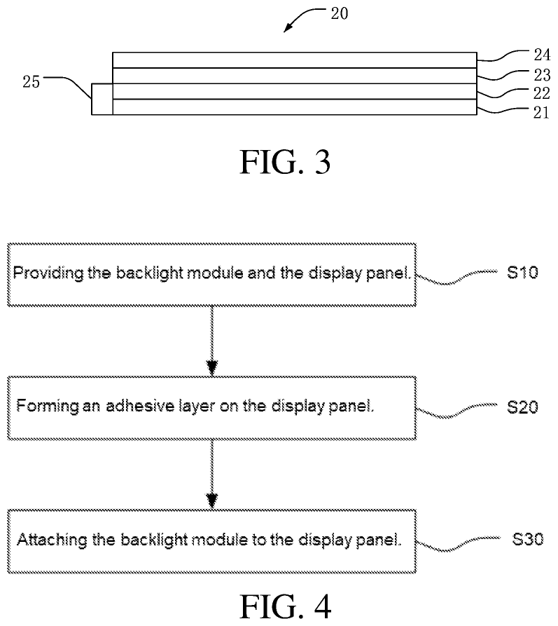

As shown in FIG. 3, the backlight module 20 is a planar uniform illumination device, and the backlight 25 is arranged on one side or both sides of the entire backlight module 20. The backlight 25 is generally a cold cathode fluorescent lamp (CCFL) or a light-emitting diode (LED) strip. The cold cathode fluorescent lamp is a line light source, and the light-emitting diode strip is a point source. Therefore, converting a line source and a point source to a surface source requires use of a light guide plate 22.

The light guide plate 22 is prepared by a method of injection molding to form a plate having a smooth surface using propylene, and then printing diffusion points on the bottom surface of the light guide plate 22 by screen printing using a material having high reflection and not absorbing light. The cold cathode fluorescent lamp or the light-emitting diode strip is disposed on sides of the light guide plate 22, light emitted thereof is reflected into the interior of the light guide plate 22. When light hits the diffusion points, the reflected light will diffuse at various angles, then disobey reflection condition, and be emitted from the front surface of the light guide plate 22. The light guide plate 22 can be uniformly illuminated by using various densities and sizes of diffusion points.

A purpose of the reflective film 21 is to reflect the light hit on a bottom surface back into the light guide plate 22 for improving light use efficiency. The light guide plate 22 and the reflection film 21 are used to guide scattering and reflecting directions of light, facilitating light not emitted from areas other than the light-emitting surface, thereby improving brightness of the backlight module 20 and ensuring uniform brightness of the display panel 10.

The diffusion film 23 is generally disposed on a surface of the light guide plate 22 away from the reflection film 21. Chemical particles are added in the diffusion film 23 as scattering particles. In current diffusion plates, microparticles are dispersed among resin layers, so when light passes through the diffusion layer, it will continue to pass through two different refractive index media. At the same time, the light will undergo many refractions, reflections, and scatterings, thus causing effect of optical diffusion.

The prism sheet 24 is a layer of transparent plastic film with a thickness ranging from 50 microns to 300 microns. An upper surface of the prism sheet 24 is uniformly covered with a layer of prism structures. The prism sheet is disposed on a surface of the diffusion film 23 away from the light guide plate 22, and used to improve angular distribution of light. It can concentrate light which uniformly diffuses to various angles and is emitted from the diffusion film 23, to an axial angle, that is the front view angle, thereby improving axial brightness without increasing total luminous flux.

A main effect of the optical film structure layers on the backlight module 20 is to improve the front view brightness, or called axial brightness, of the backlight module 20 without adding numbers of the backlight 25, to improve angular distribution of light, concentrating light to the front view angle, to reduce loss, and to increase total luminous flux.

The adhesive layer 30 is disposed between the backlight module 20 and the display panel 10, as shown in FIG. 2, and corresponds to the non-display area 102 of the display screen 100. The width of the adhesive layer 30 is less than 0.5 mm. Further, it can range from 0.2 mm to 0.3 mm. The width is 0.2 mm in the embodiment. The adhesive layer 30 has an optical density of 4.8, and its color is black. Material of the adhesive layer 30 is a hot melt adhesive. The hot melt adhesive can be cured quickly in an environment of 40° C. to 60° C. In addition, it has high viscosity to prevent a phenomenon of peeling between the backlight module 20 and the display panel 10 that causing water vapor intrusion and etching devices in the display screen 100. The hot melt adhesive has low fluidity, which facilitates controlling the width of the adhesive layer 30 and reducing the width of the adhesive layer 30, thereby reducing the non-display area 102 of the display screen 100, increasing the display area 101, and further achieving full screens. The hot melt adhesive also facilitates return of the display screen 100 to the factory for reworking. The hot melt adhesive will re-melt and facilitate to rework due to molecular chain breaking and loss of viscosity in a high temperature when put in an environment having temperature ranging from 80° C. to 100° C.

An embodiment of the present disclosure further provides a display device 1000. The display device 1000 comprises the above display screen 100. The display device 1000 can be any products or components having display functions, such as liquid crystal displays, mobile phones, tablet computers, laptops, digital cameras, navigators, etc.

The display screen 100 provided in the embodiment of the present disclosure uses a hot melt adhesive as the adhesive layer 30 bonding the backlight module 20 and the display screen 100, preventing water vapor intrusion, improving reliability, reducing area of the non-display area 102, increasing the display area 101, and improving screen ratio, thereby achieving full screens. Meanwhile, the hot melt adhesive also facilitates return to factories for reworking of the display screen 100, thereby reducing human and material resources, and reducing costs.

An embodiment of the present disclosure further provides a manufacturing method of the display screen 100, and the flowchart is as shown in FIG. 4. The specific steps comprise:

step S10: providing the backlight module 20 and the display panel 10. The backlight module 20 includes the backlight 25 and optical films, such as the reflection film 21, the light guide plate 22, the prism sheet 24, and the diffusion film 23. The display panel 10 includes substrates, such as an array substrate and a color filter substrate.

Step S20: forming an adhesive layer 30 on the display panel 10: coating the hot melt adhesive on edges of one surface of the display panel 10 by time pressure dispensing method to form the adhesive layer 30. The adhesive layer 30 corresponds to the non-display area 102 of the display screen 100. The width of the adhesive layer 30 is less than 0.5 mm. Further, it can range from 0.2 mm to 0.3 mm. A color thereof is black.

Step S30: attaching the backlight module 20 to the display panel 10: attaching the backlight module 20 to a surface of the adhesive layer away from the display panel 10, and placing the backlight module 20 and the display panel 10 in an environment at a temperature of 40° C. to 60° C., heating for 1 minute to 5 minutes. To be more specifically, the adhesive layer 30 is heated and cured at 50° C. for 2 minutes, making the backlight module 20 and the display panel 10 bonded firmly, and forming the display screen 100.

The manufacturing method of the display screen 100 provided by the embodiment of the present disclosure is simple, time for preparation is short, and it can save many human and material resources to achieve an object of reducing costs.

The present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims. It should be understood that, the different dependent claims and the features described herein may be combined in a manner different from that described in the original claims. It should also be appreciated that features described in connection with the individual embodiments can be used in other described embodiments.

What is claimed is:

1. A display screen having a display area and a non-display area surrounding the display area, comprising:
a backlight module;
a display panel disposed on the backlight module;
an adhesive layer disposed between the backlight module and the display panel, and corresponding to the non-display area;
wherein material of the adhesive layer is a hot melt adhesive.

2. The display screen according to claim 1, wherein a curing temperature of the hot melt adhesive ranges from 40° C. to 60° C., and a melting temperature of the hot melt adhesive ranges from 80° C. to 100° C.

3. The display screen according to claim 1, wherein a width of the adhesive layer is less than 0.5 mm.

4. The display screen according to claim 3, wherein the width of the adhesive layer ranges from 0.2 mm to 0.3 mm.

5. The display screen according to claim 1, wherein a color of the adhesive layer is black.

6. A manufacturing method of a display screen, comprising:
providing a backlight module and a display panel;
forming an adhesive layer on the display panel;
attaching the backlight module to a surface of the adhesive layer away from the display panel, wherein material of the adhesive layer is a hot melt adhesive.

7. The manufacturing method of the display screen according to claim 6, wherein the step of forming the adhesive layer on the display panel comprises: forming the adhesive layer on edges of one surface of the display panel by time pressure dispensing method.

8. The manufacturing method of the display screen according to claim 6, wherein the step of attaching the backlight module to the adhesive layer further comprises: placing the adhesive layer in an environment at a temperature of 40° C. to 60° C. and heating for 1 minute to 5 minutes to cure.

9. The manufacturing method of the display screen according to claim 6, wherein a width of the adhesive layer is less than 0.5 mm, and a color of the adhesive layer is black.

10. A display device, comprising the display screen according to claim 1.
